(19) United States
(12) Patent Application Publication
(10) Pub. No.: US 2026/0170138 A1
(43) Pub. Date: Jun. 18, 2026

(54) COMPUTER SYSTEMS AND METHODS FOR ESTABLISHING TRUST IN MACHINE LEARNING MODELS

(71) Applicant: Capital One Financial Corporation, McLean, VA (US)

(72) Inventor: Daniel A. Gisolfi, Hopewell Junction, NY (US)

(21) Appl. No.: 18/978,992

(22) Filed: Dec. 12, 2024

(51) Int. Cl. G06F 21/57; G06F 8/60

(52) U.S. Cl. CPC G06F 21/57; G06F 8/60

(57) ABSTRACT

A computing platform configured to: (i) obtain an entity identifier for an entity, (ii) based on the entity identifier, generate user-specific role credentials for attesters associated with the entity, (iii) determine assessment criteria for evaluating trustworthiness of an ML model, including digital signatures for attestations related to production of the ML model, each attestation incorporating a user-specific role credential of a respective attester, (iv) define a schema for a data record, wherein the schema incorporates the assessment criteria, (v) generate an extension for deployment within a bill-of-materials for the ML model, wherein the extension is executable to (a) create the data record according to the schema and (b) receive information to update the data record, the information including a digital signature for a respective attestation that has been digitally encrypted using a user-specific role credential for an attester, and (vi) deploy the extension within the bill-of-materials for the ML model.

### BACKGROUND

Machine learning models (ML models) are becoming integrated into society at a fast rate. Consumers of ML models may have concerns that ML models are not produced according to ethical standards. It is therefore becoming increasingly important for model producers to establish trust with potential and existing consumers their ML models have been produced according to ethical standards.

### OVERVIEW

Disclosed herein is new software technology for deploying and utilizing an “Ethical AI Trust Extension” within a bill of materials for an ML model (ML-BOM) that provides a framework for establishing ethical trust in the ML model.

In one aspect, the disclosed software technology may take the form of a method to be carried out by a computing platform that involves (i) obtaining, from an issuer, an entity identifier for an entity associated with the computing platform, (ii) based on the entity identifier, generating one or more user-specific role credentials for respective attesters associated with the entity, (iii) determining a set of assessment criteria for evaluating trustworthiness of an ML model, the set of assessment criteria including a set of digital signatures for respective attestations related to production of the ML model, each attestation incorporating a user-specific role credential of a respective attester, (iv) defining a schema for a trust assessment data record, wherein the schema incorporates the set of assessment criteria, (v) generating an extension for deployment within a bill-of-materials for the ML model (ML-BOM), wherein the extension is executable to both (a) create the trust assessment data record according to the schema and (b) receive information to update the trust assessment data record, the information including a digital signature for a respective attestation that has been digitally encrypted using a user-specific role credential for a respective attester, and (vi) deploying the extension within the ML-BOM for the ML model.

The attestations may take various forms, and in some example embodiments, each respective attestation may be related to production of a lifecycle phase of the ML model. And in such example embodiments, the lifecycle phase of the ML model may include at least one of (i) a data gathering lifecycle phase of the ML model, (ii) a data readiness lifecycle phase of the ML model, (iii) a model training lifecycle phase of the ML model, or (iv) a model monitoring lifecycle phase of the ML model.

Further, the set of assessment criteria may take various forms. As one example, in some example embodiments, the set of assessment criteria may further include at least one of (i) an aggregation of the first score for the first lifecycle phase-specific question and the second score for the second lifecycle phase-specific question, (ii) a cumulative score for the ML model, (iii) an acceptable score for the lifecycle phase of the ML model, or (iv) an acceptable score for the ML model.

As another example, in some example embodiments, the set of assessment criteria may further include a first score for a first lifecycle phase-specific question related to the lifecycle phase of the ML model and a second score for a second lifecycle phase-specific question related to the lifecycle phase of the ML model. The lifecycle phase-specific questions may take various forms, and in some example embodiments, the first lifecycle phase-specific question may be for a first data source associated with the lifecycle phase of the ML model, and the second lifecycle phase-specific question may be for a second data source associated with the lifecycle phase of the ML model. Further, in such example embodiments, the first data source may be different from the second data source, and the first lifecycle phase-specific question and the second lifecycle phase- specific question may be the lifecycle phase-specific question.

Further yet, in some example embodiments, the method may further involve (vii) receiving an indication of user input indicating the set of assessment criteria, and in such implementations, the function of determining the set of assessment criteria may involve determining the set of assessment criteria based on the received indication.

Further yet, in some example embodiments, the extension may also be executable for viewing the trust assessment data record.

Further yet, in some example embodiments, the one or more user-specific role credentials for respective attesters associated with the entity may include (i) the entity identifier for the entity and (ii) an autonomic identifier (AID) for the entity. And in such example embodiments, the digital signature for the respective attestation may include a hashed representation of the respective attestation that has been encrypted with a private key that corresponds to the AID.

In another aspect, the disclosed technology may take the form of a client device comprising at least one processor, at least one non-transitory computer-readable medium, and program instructions stored on the at least one non-transitory computer-readable medium that are executable by the at least one processor such that the client device is configured to carry out the functions of the aforementioned method.

In yet another aspect, the disclosed technology may take the form of a non-transitory computer-readable medium comprising program instructions stored thereon that are executable to cause a client device to carry out the functions of the aforementioned method.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1 depicts an example network configuration in which example embodiments may be implemented.

FIG. 2 depicts an example block diagram of an ethical AI trust extension being deployed within a bill of materials for a machine learning model (ML-BOM), in accordance with the present disclosure.

FIG. 3 depicts an example ecosystem that illustrates how the digital signature may be created and used to verify the authenticity of a trust assessment data record, in accordance with the present disclosure.

FIG. 4 depicts an example flow diagram of an example process that may be carried out to deploy an Ethical AI Trust Extension, in accordance with the present disclosure.

FIG. 5 depicts a representation of a portion of an example schema, in accordance with the present disclosure.

FIG. 6 depicts an example flow diagram of an example process that may be carried out to create a trust assessment data record, in accordance with the present disclosure.

FIG. 7 depicts an example representation of an attestation within a trust assessment data record for a data gathering lifecycle phase, in accordance with the present disclosure.

FIG. 8 depicts an example flow diagram of an example process that may be carried out to verify a trust assessment data record, in accordance with the present disclosure.

FIG. 9 is a simplified block diagram that illustrates some structural components of an example computing platform that may be configured to carry out any of the various functions disclosed herein.

FIG. 10 is a simplified block diagram that illustrates some structural components of an example client device that may be configured to carry out any of the various functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

Machine learning (ML) models are becoming entrenched into all aspects of society. These models are being leveraged to make or aid decisions in healthcare, business, government, education, and countless other disciplines.

When a model producer creates an ML model, the model producer typically utilizes a software application—either the software application used to create the ML model or a separate (e.g., external) software application—to generate a bill of materials for the ML model, which may be referred to herein as an “ML-BOM.” The ML-BOM may take the form of a data structure including data objects storing documentation for various aspects of the ML model, and may describe things such as the components and services utilized by the ML model, dependencies between said components and services, and annotations made to the ML model, etc. The data structure of the ML-BOM may take various forms, such as a Json file, among other possible forms. One benefit of the ML-BOM is that it provides some transparency for the ML model, allowing anyone with access to the ML-BOM to investigate the documentation for the ML model and know the ML model's various components, services, dependencies, and annotations, etc.

However, the transparency provided by the ML-BOM as it currently exists, while helpful in documenting the various aspects of the ML model, fails to provide a mechanism that enables a model producer to convey—and a model consumer to obtain—trust in the ML model and its outputs.

For example, users generally do not know what data was used to train a given ML model nor how such data was collected, what ML techniques were used to train the given model and whether such techniques (and the underlying data) were free from bias. In order to confidently use an ML model, a user needs to have trust that the producer of the ML model adhered to ethical principles in the production of the ML model. For example, if the model producer cannot verify that the source of data used to train the ML model is a known and trusted source, then users of the ML model may not be able to trust that the ML model will operate according to ethical principles.

While these ethical standards help provide a framework for establishing ethical trust, model producers continue to face the challenge of conveying compliance with ethical standards in a manner that is easily verifiable by consumers of the ML model. And current technology fails to provide a mechanism for a model producer to establish verifiable ethical trust in an ML model.

In view of these challenges and the shortcomings of existing technology, disclosed herein is new technology for deploying and utilizing an “Ethical AI Trust Extension” within an ML-BOM for an ML model that provides a framework for establishing ethical trust in the ML model. Ethical trust standards can be created at various levels (e.g., organization-specific standards, industry-wide standards, etc.) to provide a framework for establishing ethical trust in ML models. These ethical standards may describe criteria for things such as the integrity of data sources used for training the ML model, the provenance of each data source used for training the ML model, data cleansing practices, data training ethics, etc. The Ethical AI Trust Extension discussed herein may incorporate these and other criteria.

The Ethical AI Trust Extension may include first functionality for creating a trust assessment data record that may be accessed by different users (e.g., employees of a model producer) during the different lifecycle phases of an ML model's development. The different lifecycle phases may include, for example, a data gathering lifecycle phase (also referred to as a data provenance lifecycle phase) carried out by a data gatherer, a data readiness lifecycle phase carried out by a data preparer, a model training lifecycle phase carried out by a model trainer, and a model monitoring lifecycle phase carried out by an assessor, among other examples. Each employee responsible for a given lifecycle phase can publish and digitally sign an attestation that includes the results of an evaluation of the duties performed during the given lifecycle phase of the ML model. For instance, the employee may perform the evaluation to determine the extent to which the duties the employee performed during the given lifecycle phase of the ML model comply with a set of ethical standards. The set of ethical standards may be a set of industry-wide standards and/or a set of internal standards established by the model producer, among other possibilities. The employee may then utilize the first functionality of the Ethical AI Trust Extension to create a trust assessment data record to publish and digitally sign an attestation recording the results of the evaluation. The attestation may be encrypted using a private key, and the digital signature may include credentials that may be used to obtain a public key to decrypt the attestation. Ordinarily, the attestation may be published and digitally signed by the employee that performed the duties that are being attested to. However, in some implementations, the attestation may be published and digitally signed by someone else, such as by a supervisor or the like who may have performed the evaluation.

The trust assessment data record may include a plurality of assessment criteria. One form of assessment criteria may be authentication assessment criteria, and the employee may include values for the authentication assessment criteria including (i) a digital signature for an attestation included in the trust assessment data record, along with (ii) other authentication information that can be used to verify that the attestation was made by an authorized employee of the model producer (e.g., to verify that the employee has a role within the model producer that is tasked with performing the duties being attested to). Another form of assessment criteria may be trust assessment criteria, and the employee may include values for the trust assessment criteria to attest to an evaluation performed to determine to what extent the duties performed during the given lifecycle phase of the ML model comply with a set of ethical standards. The plurality of assessment criteria may take other forms as well. Further, the plurality of assessment criteria may be defined (e.g., by a given employee of the model producer tasked with defining the plurality of assessment criteria) based on a schema that may be defined by the given employee. The plurality of assessment criteria may be defined in other ways as well.

The Ethical AI Trust Extension's first functionality may take the form of an API, which an employee of the model producer may call to create a trust assessment data record. The Ethical AI Trust Extension's first functionality may take other forms as well.

Further, the Ethical AI Trust Extension may include second functionality for updating and/or viewing the trust assessment data record. This second functionality may be used for various purposes. As one example, an employee of the model producer may utilize the second functionality (e.g., by calling an API) to update information previously added to the trust assessment data record, e.g., based on a second evaluation of a lifecycle phase that has already been evaluated and attested to.

As another example, an employee of the model producer may utilize the second functionality to publish and digitally sign a new attestation to attest to an evaluation of duties performed during a different lifecycle phase of the ML model. In this manner, the trust assessment data record may first be created to record an attestation for an evaluation of duties performed during a first lifecycle phase of the ML model (e.g., a data gathering lifecycle phase), and may later be updated to include attestations for evaluations of duties performed during other lifecycle phases of the ML model—such that the trust assessment data record may ultimately include attestations for evaluations of duties performed for each lifecycle phase of the ML model.

As yet another example, an individual or entity tasked with verifying the ML model (e.g., an employee of a potential consumer of the ML model) may utilize the second functionality to view the trust assessment data record to determine whether the ML model is ethically trustworthy, e.g., by verifying the digital signature(s) included in the trust assessment data record and by evaluating the attestation(s) included in the trust assessment data record for the various lifecycle phases of the ML model.

Various other examples may also exist.

The disclosed technology improves upon existing technology for establishing verifiable ethical trust in ML models in various ways. Whereas typical ML-BOMs provide some measure of transparency into the components, services, and the like of ML models, the disclosed technology improves upon typical ML-BOMs by providing an Ethical AI Trust Extension that enables model producers to verifiably attest to the ethical soundness of their ML models. Through the use of digital signatures and other authentication information that may be included in attestations, the model producer may enable a verifier to confirm that the attestations were made by authorized employees of the model producer.

The disclosed technology improves upon existing technology for establishing verifiable ethical trust in ML models in other ways as well.

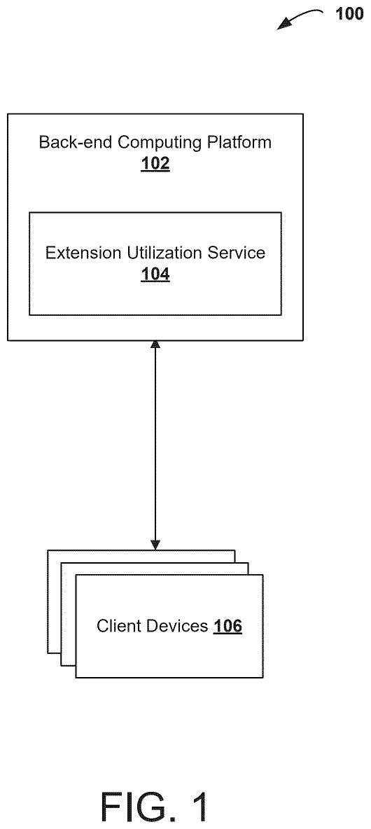

Turning now to the figures, FIG. 1 depicts an example network configuration 100 in which the disclosed technology may be implemented. As shown in FIG. 1, the example network configuration 100 includes a back-end computing platform 102 and a plurality of client devices 106.

Broadly speaking, the back-end computing platform 102 may comprise one or more computing systems that collectively comprise some set of physical computing resources (e.g., one or more processors, one or more data stores, one or more communication interfaces, etc.) along with back-end software for carrying out the back-end functionality disclosed herein. As one possibility, the back-end computing platform 102 may comprise cloud computing resources supplied by a third-party provider of “on demand” cloud computing resources, such as Amazon Web Services (AWS), Amazon Lambda, Google Cloud, Microsoft Azure, or the like. As another possibility, the back-end computing platform 102 may comprise “on-premises” computing resources of the given software provider (e.g., servers owned by the given software provider). As yet another possibility, the back-end computing platform 102 may comprise a combination of cloud computing resources and on-premises computing resources. Other implementations of the back-end computing platform 102 are possible as well.

In accordance with the present disclosure, the back-end computing platform 102 may be provisioned with a functional component implemented in software that is configured to perform back-end functionality for enabling users to deploy and utilize the Ethical AI Trust Extension within the ML-BOM generated for an ML model, in line with the disclosure above. This functional component may be referred to herein as the “extension utilization service” 104. In some implementations, the extension utilization service 104 may be part of the software application utilized for generating the ML-BOM, while in other implementations, the extension utilization service 104 may be separate from the software application utilized for generating the ML-BOM.

The back-end computing platform 102 may include various other functional components as well. Further, in practice, the functional components disclosed herein may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Turning to the client devices 106, each client device 106 may generally take the form of any computing device that is capable of running client-side software for interacting with the back-end computing platform 102. In this respect, each client device 106 may include hardware components such as one or more processors, computer readable mediums, communication interfaces, and input/output (I/O) components (or interfaces for connecting thereto), among other possible hardware components, as well as software components such as operating system (OS) software, web browser software, and/or other client-side software for accessing and interacting with the back-end computing platform 102, among other possible software components. As representative examples, each client device 106 may take the form of a desktop computer, a laptop, a netbook, a tablet, a smartphone, or a personal digital assistant (PDA), among other possibilities.

As further depicted in FIG. 1, each client device 106 may be configured to communicate with the back-end computing platform 102 over a respective communication path. Each of these communication paths may generally comprise one or more data networks and/or data links, which may take any of various forms. For instance, each respective communication path between a client device 106 and the back-end computing platform 102 may include any one or more of a Personal Area Network (PAN), a Local Area Network (LAN), a Wide Area Networks (WAN) such as the Internet or a cellular network, a cloud network, and/or a point-to-point data link, among other possibilities, where each such data network and/or link may be wireless, wired, or some combination thereof, and may carry data according to any of various different communication protocols. Additionally, the communication between a client device 106 and the back-end computing platform 102 may be carried out via an Application Programming Interface (API) provided by the back-end computing platform 102, among other possibilities. Although not shown, the respective communication paths between the client devices 106 and the back-end computing platform 102 may also include one or more intermediate systems, examples of which may include a data aggregation system and host server, among other possibilities. Many other configurations are also possible.

It should be understood that the example network configuration 100 depicted in FIG. 1 is one example of a network configuration in which the disclosed technology may be implemented. Numerous other arrangements are possible and contemplated herein. For instance, other network configurations may include additional components not pictured and/or more or fewer of the pictured components.

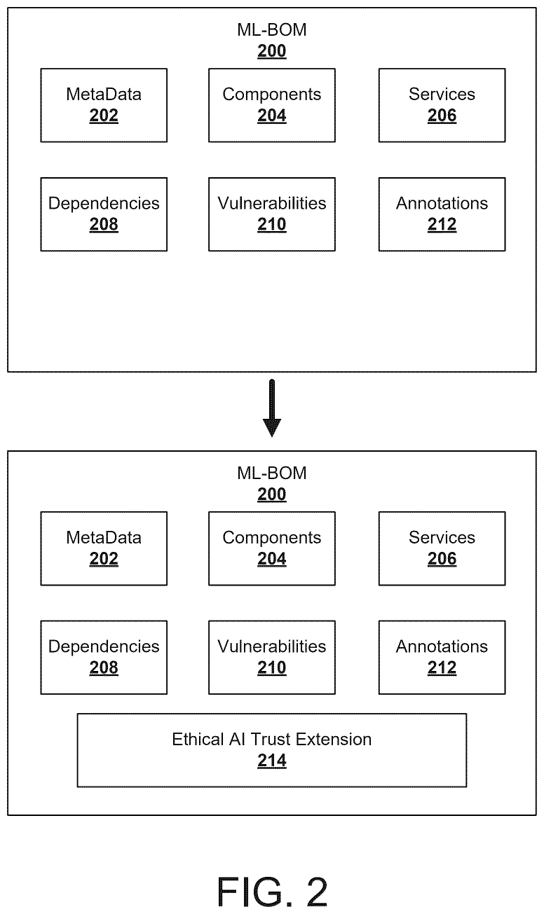

In line with the previous discussion, a model producer may use the extension utilization service 104 to generate and deploy an Ethical AI Trust Extension within an ML-BOM for an ML model. FIG. 2 shows an example block diagram of the disclosed Ethical AI Trust Extension being deployed within an example ML-BOM 200 of an example ML model.

As shown, prior to the Ethical AI Trust Extension being deployed within the ML-BOM 200, the example ML-BOM 200 may initially include the following data objects: (i) a “Metadata” data object 202, which may include documentation for the manufacturer of the ML model, the tools used to create the ML-BOM 200 and/or the ML model, license information for the ML-BOM 200, among other possible metadata, (ii) a “Components” data object 204, which may include documentation for the various software, hardware, source code, etc. used to create the ML model, (iii) a “Services” data object 206, which may include documentation for any APIs called by the ML model, among other services, (iv) a “Dependencies” data object 208, which may include documentation for the various dependencies between the components and services of the ML model, (v) a “Vulnerabilities” data object 210, which may include documentation for any known vulnerabilities introduced by any of the components or services of the ML model, and (vi) an “Annotations” data object 212, which may include documentation for annotations made to the ML model and/or the ML-BOM 200. It should be noted that prior to the Ethical AI Trust Extension being deployed within the ML-BOM 200, the ML-BOM 200 may include more or fewer data objects than those shown.

After the Ethical AI Trust Extension has been deployed within the ML-BOM 200, the ML-BOM 200 may now include, in addition to the data objects previously described: (vii) an “Ethical AI Trust Extension” data object 214. In line with the previous discussion, the Ethical AI Trust Extension data object 214 may include documentation and functionality for creating, updating, and/or viewing trust assessment data records, among other things.

Further details regarding how the Ethical AI Trust Extension 214 is generated, deployed, and utilized are included below.

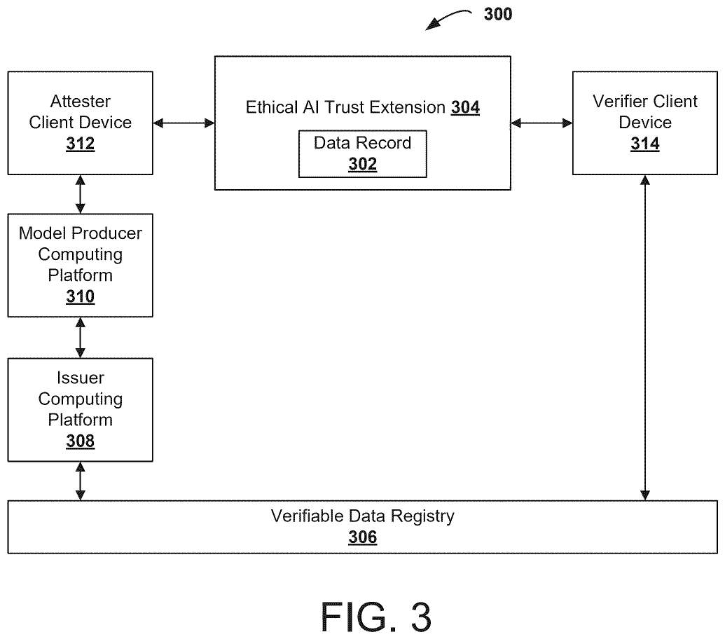

In line with the previous discussion, an attester may digitally sign an attestation within a trust assessment data record to verify that the attester was authorized to make the attestation. FIG. 3 depicts an example ecosystem 300 that illustrates how the digital signature may be created and added to a trust assessment data record 302 via an Ethical AI Trust Extension 304 deployed within an ML-BOM of an ML model, as well as how the authenticity of the trust assessment data record 302 may be verified using the digital signature.

As shown, the example ecosystem 300 includes a verifiable data registry 306 that may manage the issuance and verification of credentials, among other things. To accomplish this, the verifiable data registry 306 may generate and store autonomic identifiers (AIDs) that establish unique private key-public key pairs associated with credentials managed by the verifiable data registry 306. For instance, when a credential is created for an entity, the verifiable data registry 306 may generate and store an AID for that credential that identifies the entity and establishes a unique private key-public key pair associated with the credential. Information may be encrypted using the private key and decrypted using the public key. To decrypt information that has been encrypted using the private key, an entity that has access to the AID for the credential may provide the AID to the verifiable data registry 306 and obtain, from the verifiable data registry 306, the public key associated with the AID, which may then be used to decrypt the information. Various other examples may also exist.

The verifiable data registry 306 may take various forms, such as a distributed ledger, among other possibilities.

The example ecosystem 300 also includes an issuer computing platform 308. The issuer computing platform 308 may be associated with an organization or entity that obtains registration information from entities seeking to obtain credentials, creates credentials for said entities, and then transmits the credentials to said entities.

The credentials that the issuer computing platform 308 creates may take any of various forms. One example of such a credential may be a verifiable legal entity identifier (vLEI). A vLEI may take the form of an alphanumeric code that uniquely identifies a legal entity (e.g., a person, a corporation, etc.) and may be associated with the registration information provided by the entity for which the vLEI is created, among other possibilities.

The example ecosystem 300 also includes a model producer computing platform 310, which may associated with the model producer described above that may develop and distribute ML models for use by consumers. The model producer computing platform 310 may interact with the issuer computing platform 308 to obtain a vLEI. To accomplish this, the model producer computing platform 310 may provide registration information to the issuer computing platform 308. The registration information may take various forms, and may include information such as (i) identification information for the model producer associated with the model producer computing platform 310 (e.g., the model producer's business name, business address, employer identification number (EIN), etc.), (ii) identification information for the employees of the model producer who may be assigned individual identifiers (e.g., names for the employees of the model producer, among other types of identification information), and/or (iii) organizational information for the model producer, including a description of the roles of each employee (e.g., a title) within the model producer's business organization.

Once the issuer computing platform 308 obtains the registration information from the model producer computing platform 310 and verifies the registration information, the issuer computing platform 308 may create a vLEI for the model producer and provide the vLEI to the model producer computing platform 310.

The verifiable data registry 306 may then generate and store an AID for the vLEI, establishing a unique private key-public key pair associated with the vLEI, and provide the AID to the model producer computing platform 310. In some implementations, the model producer computing platform 310 may obtain the private key from the verifiable data registry 306 and use it to encrypt information associated with the vLEI.

Once the model producer computing platform 310 has obtained the vLEI from the issuer computing platform 308, the model producer computing platform 310 may then be enabled to generate vLEI role credentials for employees of the model producer. The vLEI role credentials generated for a given employee may include (i) the vLEI of the model producer, (ii) the AID created for the vLEI, and (iii) a description of the employee's role within the model producer's business organization, along with other information that the model producer includes for the employee.

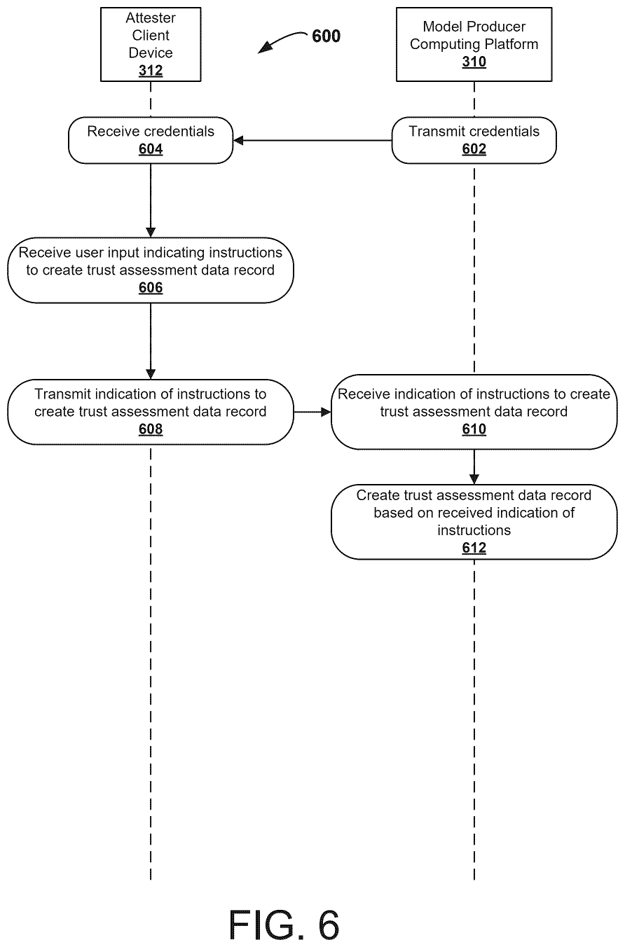

The example ecosystem 300 also includes an attester client device 312, which may be operated by an attester employed by the model producer who may be responsible for one or more of the lifecycle phases discussed above. In line with the previous discussion, one responsibility of the attester may be to publish and digitally sign respective attestations within the trust assessment data record 302 for the one or more lifecycle phases. The attester client device 312 may obtain, from the model producer computing platform 310, a vLEI role credential for the attester. The attester client device 312 may extract the AID and vLEI from the vLEI role credential, and, using the AID, obtain the private key associated with the vLEI from the verifiable data registry 306. After recording the attestation within the trust assessment data record 302 as discussed above, the attester client device 312 may then secure the attestation by (i) applying a hash function to the attestation, (ii) encrypting the hash with the private key to create a digital signature, which may include the AID and the encrypted hash, and (iii) encrypting the attestation with the private key. In this manner, the attestation recorded in the trust assessment data record 302 may include (i) a digital signature portion, including an unencrypted AID and a value for the digital signature that has been encrypted using the private key, and (ii) an attestation portion, which may be encrypted using the private key. The operations of the attester client device 312 are described in greater detail below with respect to FIG. 6.

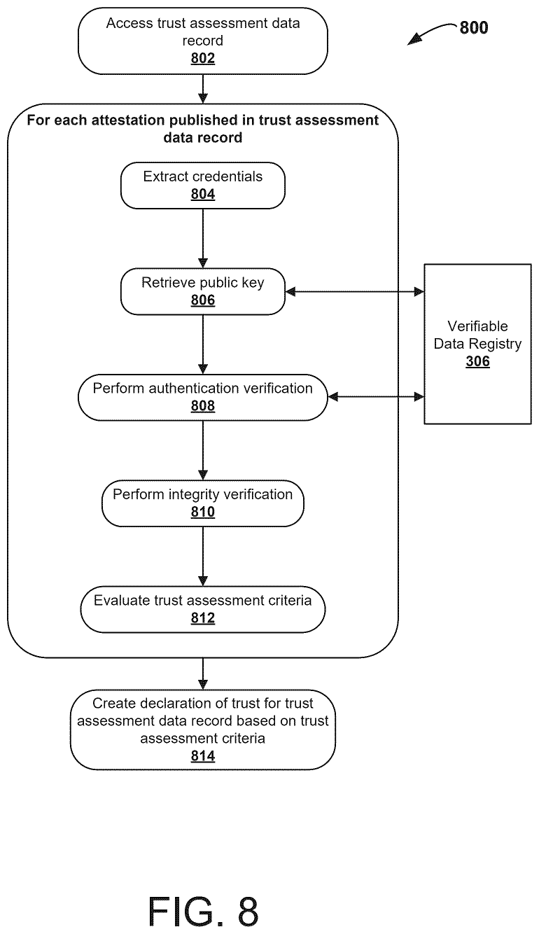

The example ecosystem 300 also includes a verifier client device 314, which may be operated by an individual or entity (e.g., a consumer of the ML model) tasked with verifying attestations made for the ML model that are recorded in the trust assessment data record 302. The verifier client device 314 may inspect the trust assessment data record 302 and extract the AID from the digital signature portion of each attestation recorded in the trust assessment data record 302. The verifier client device 314 may then obtain the public key associated with the AID from the verifiable data registry 306 and use it to decrypt—and thereby verify—the digital signature for each attestation. The verifier client device 314 may then use the public key to decrypt each attestation to obtain (i) authentication assessment criteria (e.g., information indicating the vLEI of the model producer and information indicating the vLEI role credentials of the attester operating the attester client device 312, among other possibilities) and (ii) trust assessment criteria (e.g., details regarding the duties performed during a given lifecycle phase of the ML model). For example, the verifier client device 314 may then use the authentication assessment criteria from each attestation to verify that the respective attester operating the attester client device 312 had the model producer's authority to make the attestation. The verifier client device 314 may also evaluate the trust assessment criteria to determine whether the ML model was produced in a manner that complies with a given set of ethical standards to a satisfactory degree. The operations of the verifier client device 314 are described in greater detail below with respect to FIG. 8.

The various communications between the verifiable data registry 306, the issuer computing platform 308, the model producer computing platform 310, the attester client device 312, and the verifier client device 314 may occur over one or more communication paths, each of which may be similar to the communication paths previously described with respect to FIG. 1.

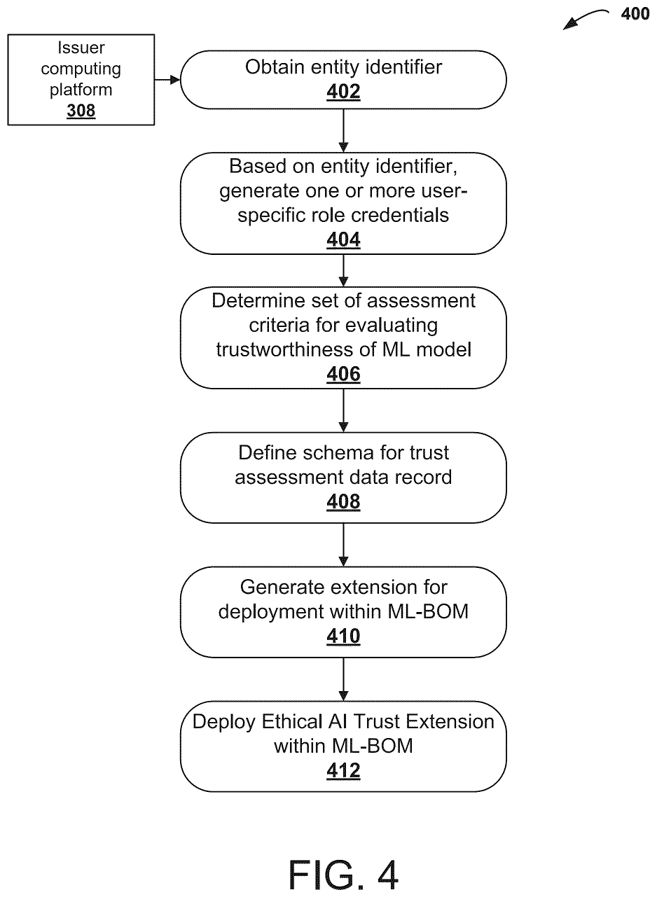

Turning now to FIG. 4, an example flow diagram of an example process 400 that may be carried out to deploy the Ethical AI Trust Extension within an ML-BOM for an ML model created by a model producer in accordance with the present disclosure is shown. For purposes of illustration only, the example process 400 is described as being carried out by the model producer computing platform 310 within the example ecosystem 300 of FIG. 3. It should be understood, however, that this functionality may be carried out by any of various other devices in any of various other ecosystems. Further, for simplicity, the example process 400 is described as being carried out after the ML-BOM for an ML model has already been generated. However, it should be understood that in practice, the example process 400 may be carried out as the ML-BOM is being generated. For instance, deploying the Ethical AI Trust Extension may be part of the process for generating the ML-BOM.

Starting at block 402, the model producer computing platform 310 may obtain an entity identifier (e.g., a vLEI) from the issuer computing platform 308. For instance, the model producer computing platform 310 may provide registration information to the issuer computing platform 308, and the issuer computing platform 308 may, after obtaining and verifying the registration information, create a vLEI for the model producer and provide the vLEI to the model producer computing platform 310. Further, in some implementations the model producer computing platform 310 may also receive an AID that may have been created for the vLEI, e.g., by the verifiable data registry 306, in line with the previous discussion.

At block 404, the model producer computing platform 310 may, based on the obtained entity identifier, generate one or more user-specific role credentials (e.g., vLEI role credentials). As one possibility, the model producer computing platform 310 may generate a respective user-specific role credential for each employee of the model producer who is responsible for attesting to one or more lifecycle phases of the ML model. As another possibility, the model producer computing platform 310 may generate a respective user-specific role credential for each employee of the model, including employees who are not responsible for attesting to lifecycle phases of the ML model.

At block 406, the model producer computing platform 310 may determine a set of assessment criteria for evaluating trustworthiness of the ML model. As described in greater detail below, the set of assessment criteria may be incorporated into a schema for use in creating trust assessment data records, which may take the form of a data structure that includes the set of assessment criteria.

The model producer computing platform 310 may determine the set of assessment criteria in various ways. As one possibility, the model producer computing platform 310 may determine the set of assessment criteria based on an indication of a user selection of the set of assessment criteria. For instance, a user (e.g., an employee of the model producer tasked with deploying the Ethical AI Trust Extension) may be operating a client device (e.g., the attester client device 312, or any other client device) that is installed with client-side software for interacting with the extension utilization service 104. The client device may present, to the user, a user interface that includes one or more selectable icons for defining the set of assessment criteria. The selectable icons may take any of various forms, and some example selectable icons may include (i) a dropdown list of predefined, selectable assessment criteria options and/or (ii) a data field for defining assessment criteria, among other possibilities.

The set of assessment criteria may include various types of assessment criteria. One type of assessment criteria that may be included in the set of assessment criteria may include background information, such as background information for the schema that the set of assessment criteria is to be incorporated into (e.g., a schema name, a schema version number, etc.), and possibly timestamp information for when a trust assessment data record is created, updated, viewed, etc., among other possibly types of background information. The user may specify that trust assessment data records created via the Ethical AI Trust Extension are to include data fields for inputting background information for the schema.

Another type of assessment criteria that may be included in the set of assessment criteria may include authentication assessment criteria. One authentication assessment criterion may take the form of a digital signature that may be added by an employee of the model producer for an attestation, in line with the previous discussion. The digital signature may include (i) an AID generated for a vLEI of the model producer and (ii) a value of the digital signature, which may be generated by hashing the attestation included in the trust assessment data record, among other possibilities. For instance, the user may specify that trust assessment data records created via the Ethical AI Trust Extension are to include data fields for inputting digital signatures, and each trust assessment data record may include a respective data field for inputting a digital signature for each lifecycle phase attested to in the trust assessment data record.

Another authentication assessment criterion may take the form of an identifier (e.g., a name, or other identifier) for an employee who makes an attestation within a trust assessment data record. For instance, the user may specify that trust assessment data records created via the Ethical AI Trust Extension are to include data fields for inputting employee identifiers, and each trust assessment data record may include a respective data field for inputting an employee identifier for each lifecycle phase attested to in the trust assessment data record.

Yet another authentication assessment criterion may take the form of an indication of an employee role within the business organization of the model producer that is held by an employee who makes an attestation within a trust assessment data record. For instance, the user may specify that trust assessment data records created via the Ethical AI Trust Extension are to include data fields for inputting indications of employee roles, and each trust assessment data record may include a respective data field for inputting an employee role for each lifecycle phase attested to in the trust assessment data record.

Various other authentication assessment criteria may also exist.

Yet another type of assessment criteria that may be included in the set of assessment criteria may include trust assessment criteria. One type of trust assessment criteria may take the form of question criteria, and the example schema may include, for each of a set of questions that may be included in the schema, (i) a question ID criterion, (ii) a question prompt criterion, and (iii) a question response criterion, among other possible question criteria. For instance, the user may specify that trust assessment data records created via the Ethical AI Trust Extension are to include a set of questions. The user may specify the ID and prompt for each question, and may further specify that trust assessment data records created via the Ethical AI Trust Extension are to include data fields for inputting responses to the questions, each of which may take the form of a score that describes how well the ML model complies with a respective question.

In practice, the questions may be lifecycle phase-specific, and the user may specify a respective set of questions for each lifecycle phase. In some situations, the set of questions for a given lifecycle phase may be repeated multiple times, such as for a data gathering lifecycle phase that includes an indication of multiple data sources from which data was gathered. For such lifecycle phases, the user may specify that trust assessment data records are to include a respective set of questions (e.g., the same set of questions) for each data source. Additionally, the user may also specify that trust assessment data records created via the Ethical AI Trust Extension are to include, for each lifecycle phase, a respective data field for inputting, for each data source used in the lifecycle phase, an ID and name for each data source indicated in the lifecycle phase, as well as a number of data sources indicated in the lifecycle phase.

The questions specified by the user may provide insight into the ethical trustworthiness of the ML model, and may evaluate considerations such as (i) the lawfulness, fairness, and transparency of how the ML model was produced, (ii) the purpose behind certain actions performed during production of the ML model, (iii) the efforts made to minimize data usage in production of the ML model, (iv) the accuracy of assumptions made during production of the ML model, (v) the integrity and confidentiality of data utilized in production of the ML model, and (vi) the accountability taken by the model producer regarding any issues arising from production of the ML model, among various other considerations. Notably, none of these considerations can be evaluated using current ML-BOM solutions.

Some example lifecycle phase-specific question prompts that may be specific to a data gathering lifecycle phase may include: “Is the data source required to solve the problem that the ML model sets out to solve?”, “Has the data from this data source been collected lawfully and fairly?”, and “Can we trust the data from this data source?” As previously mentioned, these question prompts, among other possible question prompts, may be asked for each data source used during the data gathering lifecycle phase.

Some example lifecycle phase-specific question prompts that may be specific to a data readiness lifecycle phase may include: “Has the data been cleansed?”, “Do we know what features to use from the data?”, and “Have we been transparent in how we are using the data?” Other lifecycle phase-specific question prompts that may be specific to the data readiness lifecycle phase may also exist.

Some example lifecycle phase-specific question prompts that may be specific to a model training lifecycle phase may include: “Are we using the right algorithm with our data?”, “Are we able to identify unwanted bias?”, and “Can we trust what the data is telling us?” Other lifecycle phase-specific question prompts that may be specific to the model training lifecycle phase may also exist.

Some example lifecycle phase-specific question prompts that may be specific to a model monitoring lifecycle phase may include things like “Are the outputs expected?”, “Can we explain how the model arrived at the output?”, “Are we confident our model will provide fair outputs,” and “Do we know how to improve our model before deployment?” Other lifecycle phase-specific question prompts that may be specific to the model monitoring lifecycle phase may also exist.

Another type of trust assessment criteria may take the form of a cumulative score for a lifecycle phase. For instance, the user may specify that trust assessment data records created via the Ethical AI Trust Extension are to include data fields for inputting lifecycle phase cumulative scores, and each trust assessment data record may include, for each lifecycle phase attested to in the trust assessment data record, a respective data field for inputting a lifecycle phase cumulative score. The lifecycle phase cumulative score may be determined based on the responses to the questions included in the lifecycle phase. For example, the lifecycle phase cumulative score may be an aggregation of the scores included in the responses to the questions included in the lifecycle phase. In some implementations, rather than specifying that trust assessment data records created via the Ethical AI Trust Extension are to include data fields for inputting lifecycle phase cumulative scores, the user may instead cause the lifecycle phase cumulative scores to be generated automatically, e.g., by aggregating the scores recorded in the responses to the questions for each lifecycle phase attested to in the trust assessment data record. Various other possibilities may also exist.

Yet another type of trust assessment criteria may take the form of an acceptable lifecycle phase score, which may be a business-specific or industry-wide acceptable score for a lifecycle phase, among other possibilities. Further, the acceptable lifecycle phase score may be input by the user, or the user may specify that trust assessment data records created via the Ethical AI Trust Extension are to include data fields for inputting acceptable lifecycle phase scores, and each trust assessment data record may include, for each lifecycle phase attested to in the trust assessment data record, a respective data field for inputting an acceptable lifecycle phase score.

Yet another type of trust assessment criteria may take the form of a cumulative ML model score, which may be an aggregation of the scores for each lifecycle phase attested to in trust assessment data records included in the ML-BOM for the ML model. For instance, the user may specify that trust assessment data records created via the Ethical AI Trust Extension are to include data fields for inputting cumulative ML model scores, and each trust assessment data record may include a data field for inputting a cumulative ML model score for the ML model attested to in the trust assessment data record. The cumulative ML model score may be determined based on the cumulative scores for each lifecycle phase attested to in the trust assessment data record. For example, the cumulative ML model score may be an aggregation of cumulative scores for each lifecycle phase attested to in the trust assessment data record. In some implementations, rather than specifying that trust assessment data records created via the Ethical AI Trust Extension are to include data fields for inputting cumulative ML model scores, the user may instead cause cumulative ML model scores to be generated automatically, e.g., by aggregating the cumulative lifecycle phase scores for each lifecycle phase attested to in each trust assessment data record. Various other possibilities may also exist.

Yet another type of trust assessment criteria may take the form of an acceptable cumulative ML model score, which may be a business-specific or industry-wide acceptable score for the ML model, among other possibilities. Further, the acceptable cumulative ML model score may be input by the user, or the user may specify that trust assessment data records created via the Ethical AI Trust Extension are to include data fields for inputting acceptable cumulative ML model scores, and each trust assessment data record may include a data field for inputting an acceptable cumulative ML model score for the ML model associated with the trust assessment data record.

The trust assessment criteria may take other forms as well. Further, the model producer computing platform 310 may determine the set of assessment criteria in other ways as well. For instance, as another possibility, the set of assessment criteria may be a default set of assessment criteria. As yet another possibility, the model producer computing platform 310 may determine the set of assessment criteria based on an analysis of the ML-BOM and/or the ML-BOM. For instance, the model producer computing platform 310 may analyze the ML-BOM and/or the ML model to determine what lifecycle phases are applicable to the ML model, and then determine the set of assessment criteria according to the applicable lifecycle phases. Various other possibilities may also exist.

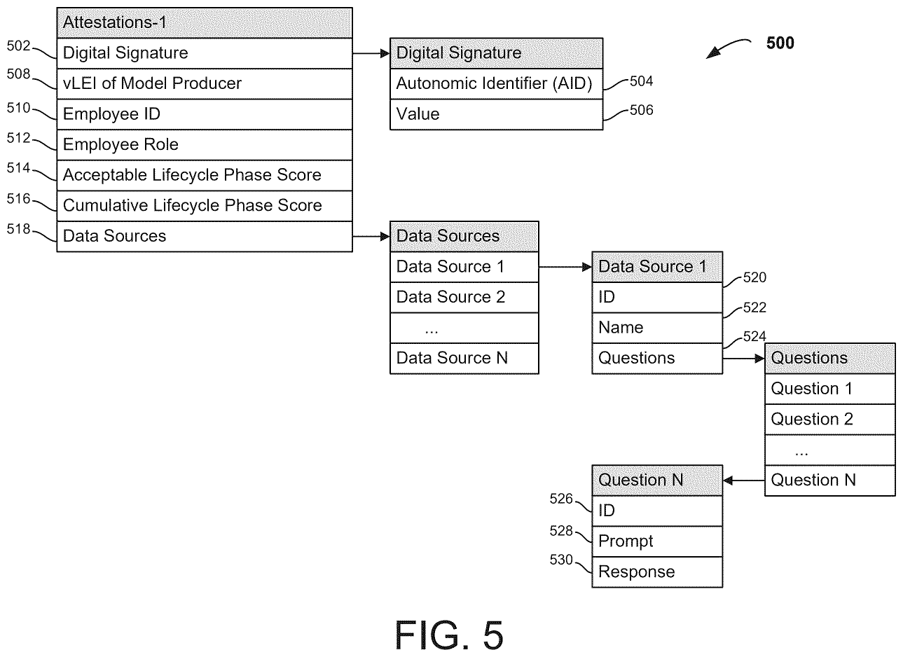

FIG. 5 depicts a representation 500 of a portion of an example schema that relates to a data gathering lifecycle phase. As shown, the example schema includes (i) a digital signature criterion 502 including an AID criterion 504 and a value criterion 506 of the digital signature, (ii) a vLEI criterion 508 of the model producer, (iii) an employee identifier criterion 510, (iv) an employee role criterion 512 describing the employee's role within the business organization of the model producer, (v) an acceptable lifecycle phase score criterion 514, (vi) a cumulative lifecycle phase score criterion 516, and (vii) for each of a set of data sources 518, a respective ID criterion 520 and name criterion 522. Further, each data source of the set of data sources 518 includes a set of question criteria 524 about the data source, wherein each question of the set of question criteria 524 includes (a) an ID criterion 526, (b) a prompt criterion 528, and (c) a response criterion 530.

In line with the previous discussion, the example schema may include more or fewer criteria than those shown in FIG. 5 for a data gathering lifecycle phase. Further, the example schema may include criteria for other lifecycle phases, as well as other criteria that is not specific to a lifecycle phase, such as background information for the example schema.

Returning to FIG. 4, at block 408, the model producer computing platform 310 may define the schema for use in creating trust assessment data records. In line with the previous discussion, the schema may take the form of a data structure that includes the set of assessment criteria determined by the model producer computing platform 310. The schema may define which lifecycle phases attestations may be published and digitally signed for in the trust assessment data records, as well as what assessment criteria is included in each lifecycle phase, among other things.

At block 410, the model producer computing platform 310 may generate an Ethical AI Trust Extension for deployment within an ML-BOM for an ML model. The model producer computing platform 310 may configure the Ethical AI Trust Extension to include the first functionality for creating trust assessment data records according to the defined schema, as well as the second functionality for updating and/or viewing the trust assessment data records, in line with the previous discussion.

At block 412, the model producer computing platform 310 may deploy the generated Ethical AI Trust Extension within the ML-BOM of the ML model. In line with the previous discussion, this may include creating a new Ethical AI Trust Extension data object within the ML-BOM of the ML model, as previously described with respect to FIG. 2.

In some implementations, the model producer computing platform 310 may perform the operations of the example process 400 via an extension utilization service, such as the extension utilization service 104 previously described with respect to FIG. 1.

Turning to FIG. 6, an example flow diagram of an example process 600 that may be carried out to create a trust assessment data record in accordance with the present disclosure is shown. For purposes of illustration only, the example process 600 is described as being carried out by the attester client device 312 and the model producer computing platform 310 within the example ecosystem 300 of FIG. 3. It should be understood, however, that this functionality may be carried out by any of various other devices in any of various other environments as well.

Beginning at block 602, the model producer computing platform 310 may transmit credentials to the attester client device 312, e.g., via the communication path between the attester client device 312 and the model producer computing platform 310. In line with the previous discussion, the credentials may include vLEI role credentials for one or more attesters employed by the model producer. Each vLEI role credential may be a user-specific role credential that is specific to a respective attester, and may include (i) the vLEI of the model producer, (ii) the AID created for the vLEI, and (iii) a description of the attester's role within the model producer's business organization, among other possibilities.

At block 604, the attester client device 312 may receive the credentials from the model producer computing platform 310, e.g., via the communication path between the attester client device 312 and the model producer computing platform 310.

At block 606, the attester client device 312 may receive user input indicating instructions to create a trust assessment data record. For instance, an attester employed by the model producer may input instructions to create a trust assessment data record so that the attester may publish and digitally sign an attestation for a given lifecycle phase of a ML model within the trust assessment data record.

The user input indicating the instructions to create the trust assessment data record may include one or more values for one or more assessment criteria incorporated in the schema defined for the Ethical AI Trust Extension to publish an attestation for the given lifecycle phase that the attester is responsible for. The user input may also include an indication of a private key to be used to encrypt and digitally sign the attestation. The user input may also include a request to create a trust assessment data record to include the encrypted and digitally signed attestation. The user input may take various other forms as well.

At block 608, the attester client device 312 may transmit an indication of the instructions to create the trust assessment data record to the model producer computing platform 310, e.g., via the communication path between the attester client device 312 and the model producer computing platform 310.

At block 610, the model producer computing platform 310 may receive the indication of the instructions to create the trust assessment data record, e.g., via the communication path between the attester client device 312 and the model producer computing platform 310.

At block 612, the model producer computing platform 310 may create the trust assessment data record based on the received indication of the instructions. For instance, the model producer computing platform 310 may add a new trust assessment data record to the ML-BOM, which may include the values for the assessment criteria input by the attester, along with other information specified by the schema (e.g., information included by an employee of the model producer input the set of assessment criteria incorporated in the schema, such as the prompts for the set of questions, among other possibilities).

It should be noted that the example process 600 of FIG. 6 can also be used to update an existing trust assessment data record. For instance, after attester has created a trust assessment data record and published and digitally signed an attestation for a first lifecycle phase, another attester responsible for a second lifecycle phase may update the trust assessment data record by publishing and digitally signing an attestation for the second lifecycle phase. This may enable the trust assessment data record to include digitally signed attestations for each lifecycle phase of the ML model.

Further, after an attester publishes and digitally signs an attestation within the trust assessment data record, the attester may leverage the ML-BOM's existing “Annotations” functionality to create an annotation to memorialize the attester's activities. The attester may include, in the annotation, information such as (i) the name of the model producer, (ii) the attester's role within the business organization of the model producer, (iii) notes describing the attester's activity while publishing and digitally signing an attestation within trust assessment data record, (iv) timestamp information for the activity, and/or (v) a digital signature, among other things.

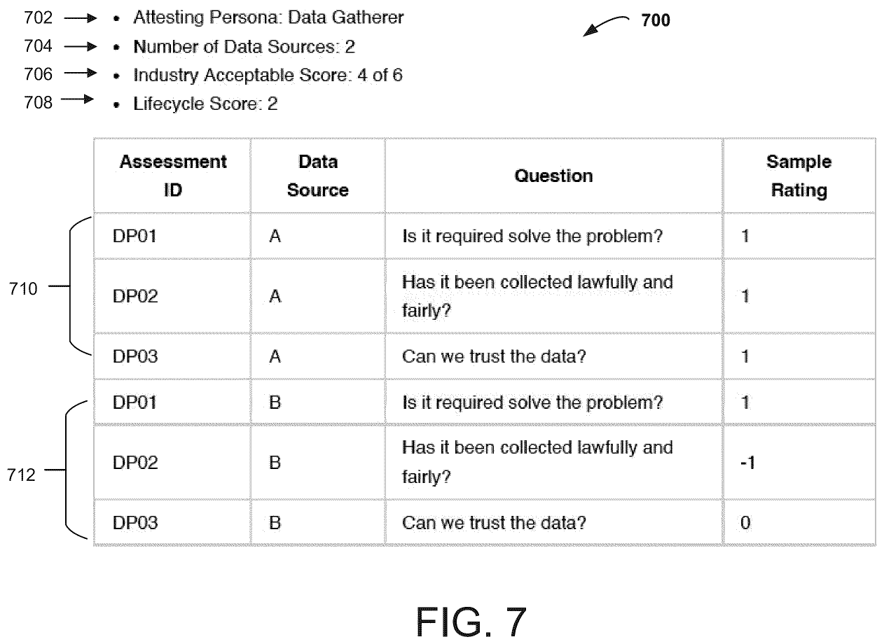

FIG. 7 shows an example representation 700 of an attestation that may be published within a trust assessment data record for a data gathering lifecycle phase by an attester, which may be created as described above with respect to FIG. 6. The example representation 700 of the attestation includes an indication 702 of the attester's role. As shown, the attester's role is a “data gatherer.” The example representation 700 of the attestation also includes an indication 704 of the number of data sources used during the data gathering lifecycle phase. As shown, the data gathering lifecycle phase used two data sources. The example representation 700 of the attestation also includes an indication 706 of an industry acceptable score for the data gathering lifecycle phase. As shown, the industry acceptable score for the data gathering lifecycle phase is 4 of 6, indicating that the cumulative score for all of the questions in the attestation (as described below) needs to be at least 4 to satisfy the industry acceptable score. The example representation 700 of the attestation also includes an indication 708 of the lifecycle score for the data gathering lifecycle phase. As shown, the lifecycle score for the data gathering phase is 2, indicating that the cumulative score for all of the questions in the attestation (as described below) is 2. As may be seen, the lifecycle score is lower than the industry acceptable score, which may indicative that the ML model associated with the attestation may not be trustworthy according to the industry standards.

The example representation 700 of the attestation also includes a first set 710 of questions for a first data source used during the data gathering lifecycle phase, as well as a second set 712 of the same questions for a second data source used during the data gathering lifecycle phase. As shown, the questions include (i) “Is it required to solve the problem?,” (ii) “Has it been collected lawfully and fairly?,” and (iii) “Can we trust the data?” Further, as shown, the example representation 700 of the attestation includes a respective rating (or response) for each question in the first and second sets 710 and 712. In the example representation 700 of the attestation, these ratings take the form of numeric values, including “1” indicating an affirmative rating, “−1” indicating a negative rating, and “0 ” indicating an uncertain rating. For instance, as shown the ratings for each question in the first set 710 is shown to be 1, indicating that the first data source is required to solve the problem, that the data has been collected from the first data source lawfully and fairly, and that the data from the first data source can be trusted. As further shown, the ratings for each question in the second set 712 is shown to be 1, −1, and 0, respectively, indicating that the second data source is required to solve the problem, that the data has not been collected from the second data source lawfully and fairly, and that it is uncertain whether the data from the second data source can be trusted. Further, although the ratings are shown as “1,” “−1,” and “0,” the ratings may take various other forms as well, including percentages, textual ratings, etc.

Turning now to FIG. 8, an example flow diagram of an example process 800 that may be carried out to verify a trust assessment data record for an ML model in accordance with the present disclosure is shown. For purposes of illustration only, the example process 800 is described as being carried out by the verifier client device 314 within the example ecosystem 300 of FIG. 3. It should be understood, however, that this functionality may be carried out by any of various other devices in any of various other environments as well.

Further, for simplicity, the example process 800 is described as being carried out after the verifier client device 314 has gained access to the ML-BOM for the ML model, including the Ethical AI Trust Extension deployed within the ML-BOM. For instance, as one possibility, the verifier operating the verifier client device 314 may be employed by a consumer of the ML model, and may have access to a copy of the ML model and ML-BOM that the consumer is in possession of (or has authorization to access), including access to the functionality of the Ethical AI Trust Extension deployed within the ML-BOM. As another possibility, the verifier may have obtained the model producer's permission to view the ML-BOM for the ML model and utilize the second functionality of the Ethical AI Trust Extension for viewing trust assessment data objects created via the Ethical AI Trust Extension, e.g., to establish ethical trust in the ML model before purchasing or promoting the ML model, among other possibilities.

Beginning at block 802, the verifier client device 314 may access the trust assessment data record. For instance, the verifier may utilize the second functionality of the Ethical AI Trust Extension to access the trust assessment data record, e.g., by interacting with client-side software installed on the verifier client device 314 for interacting with software for an extension utilization service included in the model producer computing platform 310, such as the extension utilization service 104 described with respect to FIG. 1.

Then, the verifier client device 314 may perform each of blocks 804-812 to perform various verifications and evaluations for each attestation published and digitally signed within the trust assessment data object, as described below.

At block 804, the verifier client device 314 may extract credentials from the trust assessment data record for a given lifecycle phase. In line with the previous discussion, the trust assessment data record may include a digital signature for the given lifecycle phase that includes an AID and a value of the digital signature, which has been encrypted using a private key associated with the AID. The verifier client device 314 may extract the AID from the digital signature for use in decrypting the value of the digital signature as well as the attestation, as described in greater detail below.

At block 806, the verifier client device 314 may retrieve the public key from the verifiable data registry 306. In line with the previous discussion, the verifier client device 314 may accomplish this by looking up the AID extracted from the digital signature on the verifiable data registry 306 and then retrieving, from the verifiable data registry 306, the public key associated with the AID.

At block 808, the verifier client device 314 may perform an authentication verification for the trust assessment data record. To accomplish this, the verifier client device 314 may first use the public key to decrypt the value of the digital signature. Then, the verifier client device 314 may use the public key to decrypt the attestation. If the public key is not able to decrypt either the value of the digital signature or the attestation, then the verifier client device 314 may halt the authentication verification and notify the verifier of an authentication problem (e.g., potential attester fraud). On the other hand, if the public key is able to decrypt both the value of the digital signature and the attestation, then the verifier client device 314 may continue the authentication verification by extracting the vLEI and the indication of the employee role from the decrypted attestation. The verifier client device 314 may then interact with the verifiable data registry 306 to verify (i) whether the vLEI extracted from the attestation corresponds to the AID included in the digital signature and (ii) whether the employee that made the attestation had authority from the model producer to do so. To verify whether the vLEI corresponds to the AID, the verifier client device 314 may transmit the vLEI and AID to the verifiable data registry 306, and the verifiable data registry 306 may transmit a response that indicates whether the vLEI corresponds to the AID. To verify whether the employee that made the attestation had authority from the model producer to do so (e.g., whether the employee is listed in the verifiable data registry 306 with an appropriate job title), the verifier client device 314 may submit a chain of trust verification request to the verifiable data registry 306, and the verifiable data registry 306 may transmit a response that indicates whether the attester who published and digitally signed the attestation was authorized by the model producer to do so. If the verifier client device 314 is unable to verify that the AID corresponds to the vLEI extracted from the attestation, or if the verifier client device 314 is unable to verify that the attester had authority from the model producer to publish and digitally sign the attestation, then the verifier client device 314 may halt the authentication verification and notify the verifier of an authentication problem (e.g., potential attester fraud). Alternatively, if the verifier client device 314 is able to verify that the AID corresponds to the vLEI extracted from the attestation and that the attester had authority from the model producer, then the verifier client device 314 may determine that the attestation passes the authentication verification and may provide a notification of such to the verifier using the verifier client device 314.

At block 810, the verifier client device 314 may perform integrity verification of the trust assessment data record. To accomplish this, the verifier client device 314 may leverage the ML-BOM's existing “Annotations” functionality to view annotations and determine whether an annotation has been logged that corresponds to the attestation. To accomplish this, the verifier client device 314 may scan the annotations to see if any include information that matches information for the attestation, such as a digital signature, a timestamp, etc. If no annotation has been logged that corresponds to the attestation, then the verifier client device 314 may determine that the attestation has failed the integrity verification and may provide a notification of the failed integrity verification to verifier using the verifier client device 314. Alternatively, if the verifier client device 314 identifies an annotation that corresponds to the attestation, then the verifier client device 314 may determine that the attestation passes the integrity verification and may provide a notification of such to the verifier using the verifier client device 314.

At block 812, the verifier client device 314 may evaluate the trust assessment criteria within the attestation for the lifecycle phase. To accomplish this, the verifier client device 314 may extract the trust assessment criteria from the attestation and determine whether scores included in responses to questions included in the trust assessment criteria are within an acceptable range, whether the cumulative lifecycle score included in the trust assessment criteria is within an acceptable range, and/or possibly whether the cumulative ML model score included in the trust assessment criteria is within an acceptable range. The verifier (or another employee of the consumer of the ML model) may define the acceptable range in various ways. As one possible implementation, the verifier may define the acceptable range such that the verifier client device 314 may be configured to determine that only ML models with cumulative ML model scores that meet the acceptable score indicated in the attestation are within an acceptable range. As another possible implementation, the verifier may define the acceptable range based on specific lifecycle phases of interest, such that the verifier client device 314 may be configured to determine that ML models with cumulative lifecycle phase scores for one or more lifecycle phases of interest that meet the acceptable lifecycle phase scores for the one or more lifecycle phases of interest indicated in the attestation are within an acceptable range. As yet another possible implementation, the verifier may define the acceptable range based on specific questions of interest, such that the verifier client device 314 may be configured to determine that ML models with acceptable scores included in responses to the specific questions of interest are within an acceptable range. Various other possibilities may also exist.

At block 814, the verifier client device 314 may create a declaration of trust for the trust assessment data record. For instance, the verifier client device 314 may memorialize the results of the authentication verification, the integrity verification, and the evaluation of the trust assessment criteria for each attestation included in the trust assessment data record within a declaration of trust. The declaration of trust may be a data object that is stored either locally in storage of the verifier client device 314 or some other storage where the verifier may report the results. In practice, this declaration of trust may be used by the verifier to prove that attestations for an ML model have been verified, which may help establish ethical trust in the ML model. For instance, in implementations where the verifier is employed at an organization that desires to use an ML model, the verifier may, after verifying the trust assessment data record for the ML model, memorialize the results of the verification in a declaration of trust. The organization can then rely on the declaration of trust when making decisions regarding whether and how to use the ML model, among other things.

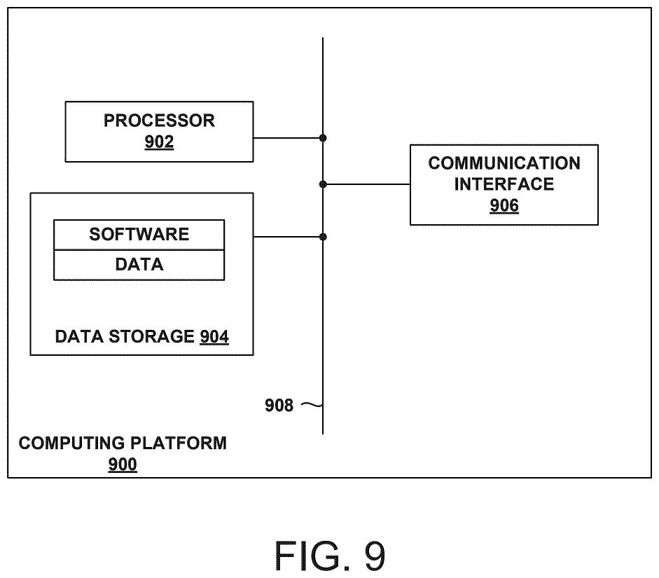

Turning now to FIG. 9, a simplified block diagram is provided to illustrate some structural components that may be included in an example computing platform 900 that may be configured to perform the server-side functions disclosed herein. At a high level, the example computing platform 900 may generally comprise any one or more computer systems (e.g., one or more servers) that collectively include one or more processors 902, data storage 904, and one or more communication interfaces 906, each of which may be communicatively linked by a communication link 908 that may take the form of a system bus, a communication network such as a public, private, or hybrid cloud, or some other connection mechanism. Each of these components may take various forms.

For instance, the one or more processors 902 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 902 could comprise processing components that are distributed across a plurality of physical computing devices connected via a network, such as a computing cluster of a public, private, or hybrid cloud.

In turn, the data storage 904 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 904 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 9, the data storage 904 may be capable of storing both (i) program instructions that are executable by the one or more processors 902 such that the example computing platform 900 is configured to perform any of the various functions disclosed herein (including but not limited to any of the server-side functions discussed above), and (ii) data that may be received, derived, or otherwise stored by the example computing platform 900.

The one or more communication interfaces 906 may comprise one or more interfaces that facilitate communication between the example computing platform 900 and other systems or devices, where each such interface may be wired and/or wireless and may communicate according to any of various communication protocols. As examples, the one or more communication interfaces 906 may take include an Ethernet interface, a serial bus interface (e.g., Firewire, USB 9.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 900 may additionally have an Input/Output (I/O) interface that includes or provides connectivity to I/O components that facilitate user interaction with the example computing platform 900, such as a keyboard, a mouse, a trackpad, a display screen, a touch-sensitive interface, a stylus, a virtual-reality headset, and/or one or more speaker components, among other possibilities.

It should be understood that the example computing platform 900 is one example of a computing platform that may be used with the examples described herein. Numerous other arrangements are possible and contemplated herein. For instance, in other examples, the example computing platform 900 may include additional components not pictured and/or more or less of the pictured components.

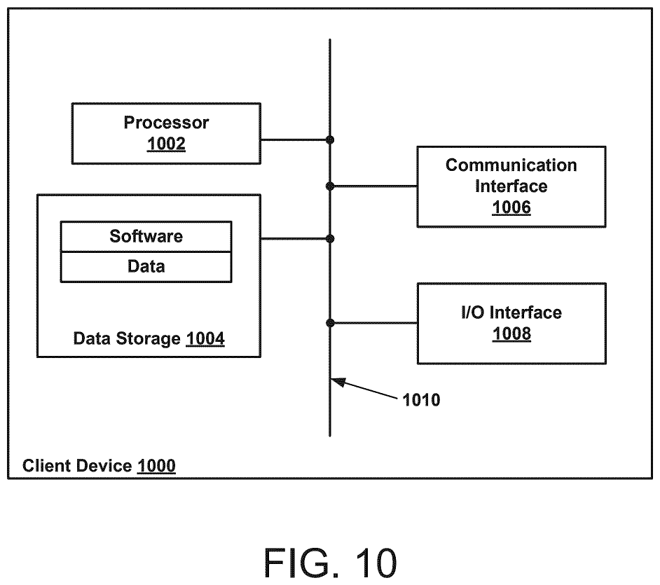

Turning next to FIG. 10, a simplified block diagram is provided to illustrate some structural components that may be included in an example client device 1000 that may be configured to perform some the client-side functions disclosed herein. At a high level, the example client device 1000 may include one or more processors 1002, data storage 1004, one or more communication interfaces 1006, and an I/O interface 1008, each of which may be communicatively linked by a communication link 1010 that may take the form a system bus and/or some other connection mechanism. Each of these components may take various forms.

For instance, the one or more processors 1002 of the example client device 1000 may comprise one or more processor components, such as one or more CPUs, GPUs, ASICs, DSPs, and/or programmable logic devices such as FPGAs, among other possible types of processing components.

In turn, the data storage 1004 of the example client device 1000 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 10, the data storage 1004 may be capable of storing both (i) program instructions that are executable by the one or more processors 1002 of the example client device 1000 such that the example client device 1000 is configured to perform any of the various functions disclosed herein (including but not limited to any of the client-side functions discussed above), and (ii) data that may be received, derived, or otherwise stored by the example client device 1000.

The one or more communication interfaces 1006 may comprise one or more interfaces that facilitate communication between the example client device 1000 and other systems or devices, where each such interface may be wired and/or wireless and may communicate according to any of various communication protocols. As examples, the one or more communication interfaces 1006 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 1008 may generally take the form of (i) one or more input interfaces that are configured to receive and/or capture information at the example client device 1000 and (ii) one or more output interfaces that are configured to output information from the example client device 1000 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 1008 may include or provide connectivity to output components such as a display screen and/or an audio speaker, among other possibilities.

It should be understood that the example client device 1000 is one example of a client device that may be used with the examples described herein. Numerous other arrangements are possible and contemplated herein. For instance, in other examples, the example client device 1000 may include additional components not pictured and/or more or fewer of the pictured components.

### IV. CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

We claim:

1. A computing platform comprising:
at least one processor;
at least one non-transitory computer-readable medium; and
program instructions stored on the at least one non-transitory computer-readable medium that, when executed by the at least one processor, cause the computing platform to:
obtain, from an issuer, an entity identifier for an entity associated with the computing platform;
based on the entity identifier, generate one or more user-specific role credentials for respective attesters associated with the entity;
determine a set of assessment criteria for evaluating trustworthiness of an ML model, the set of assessment criteria comprising a set of digital signatures for respective attestations related to production of the ML model, each attestation incorporating a user-specific role credential of a respective attester;
define a schema for a trust assessment data record, wherein the schema incorporates the set of assessment criteria;
generate an extension for deployment within a bill-of-materials for the ML model (ML-BOM), wherein the extension is executable to both (i) create the trust assessment data record according to the schema and (ii) receive information to update the trust assessment data record, the information comprising a digital signature for a respective attestation that has been digitally encrypted using a user-specific role credential for a respective attester; and
deploy the extension within the ML-BOM for the ML model.

2. The computing platform of claim 1, wherein each respective attestation is related to production of a lifecycle phase of the ML model, and wherein the lifecycle phase of the ML model comprises at least one of (i) a data gathering lifecycle phase of the ML model, (ii) a data readiness lifecycle phase of the ML model, (iii) a model training lifecycle phase of the ML model, or (iv) a model monitoring lifecycle phase of the ML model.

3. The computing platform of claim 2, wherein the set of assessment criteria further comprises a first score for a first lifecycle phase-specific question related to the lifecycle phase of the ML model and a second score for a second lifecycle phase-specific question related to the lifecycle phase of the ML model.

4. The computing platform of claim 3, wherein the first lifecycle phase-specific question is for a first data source associated with the lifecycle phase of the ML model, and wherein the second lifecycle phase-specific question is for a second data source associated with the lifecycle phase of the ML model.

5. The computing platform of claim 4, wherein the first data source is different from the second data source, and wherein the first lifecycle phase-specific question and the second lifecycle phase-specific question comprise a same lifecycle phase-specific question.

6. The computing platform of claim 3, wherein the set of assessment criteria further comprises at least one of (i) an aggregation of the first score for the first lifecycle phase-specific question and the second score for the second lifecycle phase-specific question, (ii) a cumulative score for the ML model, (iii) an acceptable score for the lifecycle phase of the ML model, or (iv) an acceptable score for the ML model.

7. The computing platform of claim 1, further comprising program instructions stored on the at least one non-transitory computer-readable medium that, when executed by the at least one processor, cause the computing platform to:
receive an indication of user input indicating the set of assessment criteria; and
wherein the program instructions that, when executed by the at least one processor, cause the computing platform to determine the set of assessment criteria comprise program instructions that, when executed by the at least one processor, cause the computing platform to determine the set of assessment criteria based on the received indication.

8. The computing platform of claim 1, wherein the extension is also executable for viewing the trust assessment data record.

9. The computing platform of claim 1, wherein the one or more user-specific role credentials for respective attesters associated with the entity comprise (i) the entity identifier for the entity and (ii) an autonomic identifier (AID) for the entity.

10. The computing platform of claim 9, wherein the digital signature for the respective attestation comprises a hashed representation of the respective attestation that has been encrypted with a private key that corresponds to the AID.

11. A non-transitory computer-readable medium, wherein the non-transitory computer-readable medium is provisioned with program instructions that, when executed by at least one processor, cause a computing platform to:
obtain, from an issuer, an entity identifier for an entity associated with the computing platform;
based on the entity identifier, generate one or more user-specific role credentials for respective attesters associated with the entity;
determine a set of assessment criteria for evaluating trustworthiness of an ML model, the set of assessment criteria comprising a set of digital signatures for respective attestations related to production of the ML model, each attestation incorporating a user-specific role credential of a respective attester;
define a schema for a trust assessment data record, wherein the schema incorporates the set of assessment criteria;
generate an extension for deployment within a bill-of-materials for the ML model (ML-BOM), wherein the extension is executable to both (i) create the trust assessment data record according to the schema and (ii) receive information to update the trust assessment data record, the information comprising a digital signature for a respective attestation that has been digitally encrypted using a user-specific role credential for a respective attester; and
deploy the extension within the ML-BOM for the ML model.

12. The non-transitory computer-readable medium of claim 11, wherein each respective attestation is related to production of a lifecycle phase of the ML model, and wherein the lifecycle phase of the ML model comprises at least one of (i) a data gathering lifecycle phase of the ML model, (ii) a data readiness lifecycle phase of the ML model, (iii) a model training lifecycle phase of the ML model, or (iv) a model monitoring lifecycle phase of the ML model.

13. The non-transitory computer-readable medium of claim 12, wherein the set of assessment criteria further comprises a first score for a first lifecycle phase-specific question related to the lifecycle phase of the ML model and a second score for a second lifecycle phase-specific question related to the lifecycle phase of the ML model.

14. The non-transitory computer-readable medium of claim 13, wherein the first lifecycle phase-specific question is for a first data source associated with the lifecycle phase of the ML model, and wherein the second lifecycle phase-specific question is for a second data source associated with the lifecycle phase of the ML model.

15. The non-transitory computer-readable medium of claim 14, wherein the first data source is different from the second data source, and wherein the first lifecycle phase-specific question and the second lifecycle phase-specific question comprise a same lifecycle phase-specific question.

16. The non-transitory computer-readable medium of claim 13, wherein the set of assessment criteria further comprises at least one of (i) an aggregation of the first score for the first lifecycle phase-specific question and the second score for the second lifecycle phase-specific question, (ii) a cumulative score for the ML model, (iii) an acceptable score for the lifecycle phase of the ML model, or (iv) an acceptable score for the ML model.

17. The non-transitory computer-readable medium of claim 11, wherein the non-transitory computer-readable medium is also provisioned with program instructions that, when executed by at least one processor, cause the computing platform to:
receive an indication of user input indicating the set of assessment criteria; and
wherein the program instructions that, when executed by at least one processor, cause the computing platform to determine the set of assessment criteria comprise program instructions that, when executed by at least one processor, cause the computing platform to determine the set of assessment criteria based on the received indication.

18. The non-transitory computer-readable medium of claim 11, wherein the extension is also executable for viewing the trust assessment data record.

19. The non-transitory computer-readable medium of claim 11, wherein the one or more user-specific role credentials for respective attesters associated with the entity comprise (i) the entity identifier for the entity and (ii) an autonomic identifier (AID) for the entity.

20. A method implemented by a computing platform, the method comprising:
obtaining, from an issuer, an entity identifier for an entity associated with the computing platform;
based on the entity identifier, generating one or more user-specific role credentials for respective attesters associated with the entity;
determining a set of assessment criteria for evaluating trustworthiness of an ML model, the set of assessment criteria comprising a set of digital signatures for respective attestations related to production of the ML model, each attestation incorporating a user-specific role credential of a respective attester;
defining a schema for a trust assessment data record, wherein the schema incorporates the set of assessment criteria;
generating an extension for deployment within a bill-of-materials for the ML model (ML-BOM), wherein the extension is executable to both (i) create the trust assessment data record according to the schema and (ii) receive information to update the trust assessment data record, the information comprising a digital signature for a respective attestation that has been digitally encrypted using a user-specific role credential for a respective attester; and
deploying the extension within the ML-BOM for the ML model.
